(19) United States
(12) Patent Application Publication
(10) Pub. No.: US 2011/0045716 A1
(43) Pub. Date: Feb. 24, 2011

(54) BUOYANT TRACK AMPHIBIOUS TRANSPORTER

(75) Inventor: Terrence W. Schmidt, Santa Clara, CA (US)

Correspondence Address: FITZPATRICK CELLA HARPER & SCINTO, 1290 Avenue of the Americas, NEW YORK, NY, 10104-3800, US

(73) Assignee: NAVATEK, LTD., Honolulu, HI (US)

(21) Appl. No.: 12/446,327

(22) PCT Filed: Oct. 18, 2007
(86) PCT No.: PCT/US07/81750

§ 371 Date: Nov. 15, 2010

Related U.S. Application Data
(60) Provisional application No. 60/852,422, filed on Oct. 18, 2006.

(51) Int. Cl. B60F 3/00

(52) U.S. Cl. 440/12.63

(57) ABSTRACT

An amphibious vehicle for transiting deep or shallow waters and/or the full range of wetland and dry soil environments, consists of a box-like structure with buoyant tracks that are powered to move around the structure. The buoyant tracks encircle the vehicle's length and extend laterally for a substantial portion of the vehicle's width or beam. When operating in water the buoyant tracks provide a majority of the buoyancy keeping the box-like structure above water surface or its tracks can be flooded to submerge the vessel. The amphibious vehicle can transport heavy equipment and personnel from ships located offshore, across undeveloped beaches, to positions ashore.

### CROSS REFERENCES TO RELATED APPLICATIONS

This application claims the benefit of U.S. Provisional Patent Application No. 60/852,422 filed Oct. 18, 2006, which is incorporated herein by reference in its entirety.

### BACKGROUND OF THE INVENTION

### Field of the Invention

This present invention relates to an amphibious tracked vehicle which can operate in water and on land.

Military and commercial operations in undeveloped regions often require the ability to transport equipment and personnel in an environment where soft soil, wetlands and water preclude the use of traditional vehicles. Often these operations require the transport of heavy equipment and personnel from ships offshore to locations ashore in areas where developed port facilities are either non-existent or are not available for use. And in certain operations the delivery of war material requires stealthy operations.

Helicopters and amphibious transporters of current design are useful but lack the ability to carry particularly heavy pieces of equipment and are not necessarily stealthy. Tracked and large low-pressure tire land transportation vehicles are common and in wide use on solid soil, but are unable to operate in water or soils with low cohesive or shear strength properties. Currently available amphibious transporters also may be unable to traverse the soft soil beach interface between the ocean and the shore.

All previous embodiments of amphibious vehicles utilize a fixed structure or hull to provide the majority of the buoyancy and tracks or wheels with a relatively small ground footprint area. This results in high footprint pressures for the propulsion system.

Other amphibious vehicles that utilize buoyant tracks, as described in U.K. Patent Application No. GB 2351707; U.S. Pat. No. 6,582,258; and U.S. Patent Publication 2004/0239102, are configured with payload and machinery spaces positioned between or above the tracks. These vehicles do not allow the tracks to extend the full width of the vehicle and this results in deeper drafts when waterborne, and higher ground footprint pressures. Additionally access to payload and machinery spaces is problematic.

### OBJECTS OF THE INVENTION

### Brief Description of the Invention

It is an object of the present invention to provide an amphibious vehicle capable of delivery payloads while propelled on land, on the sea surface or in a submerged condition.

Another object of the present invention is to provide a vehicle for delivery of heavy payloads over soft soils, wetlands and water.

Yet another object of the present invention is to provide a payload delivery vehicle in which the propulsion is provided in water and on the ground by the same propulsion system.

A further object of the present invention is to provide a payload delivery vehicle having a tracked propulsion system wherein the tracks provide motive power on and under the sea surface and on land.

A still further object of the present invention is to provide a tracked payload delivery vehicle in which the track system provides both motive power, on both land and sea, as well as buoyancy control.

In accordance with an aspect of the present invention an amphibious vehicle consists of a core box-like structure in which there are areas for the carriage of heavy equipment, personnel, propulsion and control machinery, command and control systems for the vehicle, and structure for the installation of buoyant tracks.

In accordance with another aspect of the invention the propulsion of such vehicles is derived from the motion of a belt or chain to which is affixed a number of tread or track bodies intended to achieve traction with surface water and/or the substrate or ground. The tread bodies are preferably buoyant structures that provide ground traction, as well as buoyancy and propulsion to the vehicle when it is waterborne. These track bodies occupy the majority of the width of the vehicle to produce low ground footprint pressures. The combination of a tracked vehicle and very large buoyant tracks to achieve buoyancy and traction with very low ground footprint pressure, enable the transport of large loads across water, land, and the wetland interface.

The buoyant tracks used in accordance with the invention encircle the vehicle's length and extend laterally for a substantial portion of the vehicles width or beam. The buoyant track's construction may be a singular buoyant drive track or it may be formed in multiple parts consisting of the drive track and buoyant attachments. Track buoyancy may be provided by several means including pneumatic, low density solids or foam, or a combination of buoyancy means. Buoyancy means may be contained in singular or segmented structures that are integral to or attached to the drive track. Means of powering the drive track are well known in the art of tracked vehicle propulsion.

The above and other objects, features and advantages of the present invention could be apparent to those skilled in the art from the following detailed description of an illustrative embodiment thereof when read in connection with the accompanying drawing, wherein.

### BRIEF DESCRIPTION OF THE DRAWINGS

FIG. 1 is an isometric view of an amphibious vehicle constructed in accordance with the present invention;

FIG. 2 is a perspective view similar to FIG. 1 with the vehicle's payload doors opened;

FIG. 3 is a side view of the vehicle shown in FIG. 1;

FIG. 4 is a front end view of the vehicle shown in FIG. 1; and

FIG. 5 is a side view similar to FIG. 3, but with the side wall of the vehicle removed to show the various internal components of the vehicle; and

FIG. 6 is a cross sectional view taken along line 6-6 of FIG. 3.

### DETAILED DESCRIPTION OF THE INVENTION

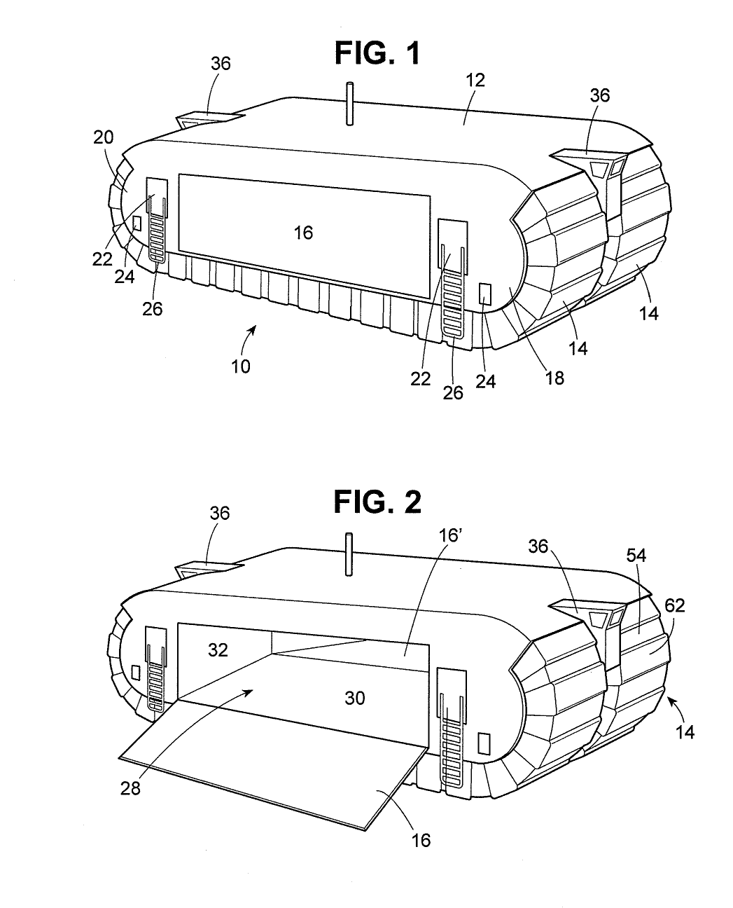

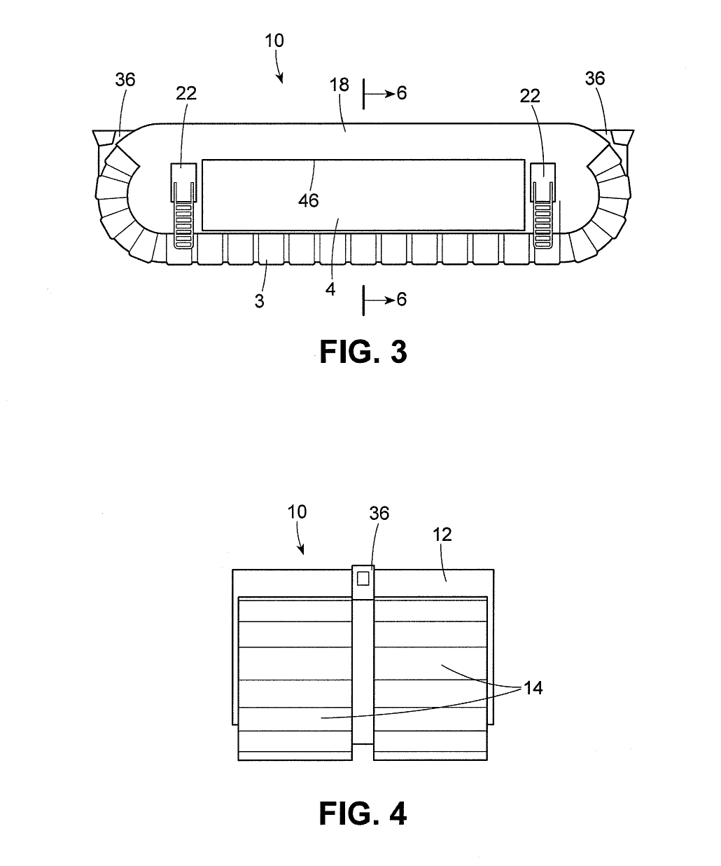

Referring now to the drawings in detail, and initially to FIG. 1, an amphibious vehicle 10, constructed in accordance with the present invention is illustrated. The vehicle consists of a body or shell-like frame 12 forming an enclosure for the vehicle and a pair of propulsion tracks 14 on opposite sides of the vehicle. As described hereinafter the housing 12 provides a preferably watertight enclosure containing a payload space and compartments for machinery and passengers. The tracks 14 are formed in any convenient manner to provide buoyant lift to the vehicle while providing tank-like traction for the vehicle while on the ground. In addition, the tracks are segmented and will also provide propulsion for the vehicle when floating on the service of the water.

As illustrated in FIG. 1, the shell or body 12 includes an elongated payload door 16 which will also serve as an unloading ramp, as shown in FIG. 2. A door 16 may be provided on either side of the vehicle. Where the vehicle is intended to be submersible the door/ramp 16 will be provided with a conventional watertight seal arrangement so that the internal payload compartment, and other compartments within the vehicle, will remain watertight.

The tracks 14, as described hereinafter, extend through the upper portion of the shell above the interior compartment enclosed by the doors 16. The shell provides passenger and/or machinery compartments 18, 20 in the fore and aft ends of the vehicle adjacent the payload compartment. These spaces are accessed by doors 22, which also would be watertight. Additional access doors 24 may also be provided for access to machinery compartments.

Because the vehicle is intended to carry large and heavy payloads, such as for example, tanks artillery and the like, the vehicle's height will be relatively substantial to accommodate that payload. Accordingly, ladders 26 are mounted on the side walls of the body or shell 12 to provide access to the doors 22.

As noted above, the door 16 when open will provide a discharge ramp for the payload contained within the vehicle. As seen FIG. 2, the ramp 16 and a corresponding ramp 16′ on the opposite side of the vehicle, are illustrated in their unloading position. The ramps are pivotally secured to the body or shell 12 in any convenient or known manner as would be apparent to those skilled in the art. Likewise, the watertight sealing arrangement, if required for the particular application in which the vehicle will be used, would be of conventional construction as would be apparent to those skilled in the art.

As seen in FIG. 2, the body or shell 12 includes an interior payload compartment 28 including a deck 30, front and rear walls 32 (only the rear wall of which is seen in FIG. 2) all of which are preferably joined together by watertight arrangements. Thus the vehicle, when landed, will be able to rapidly unload the payload from the compartment 28.

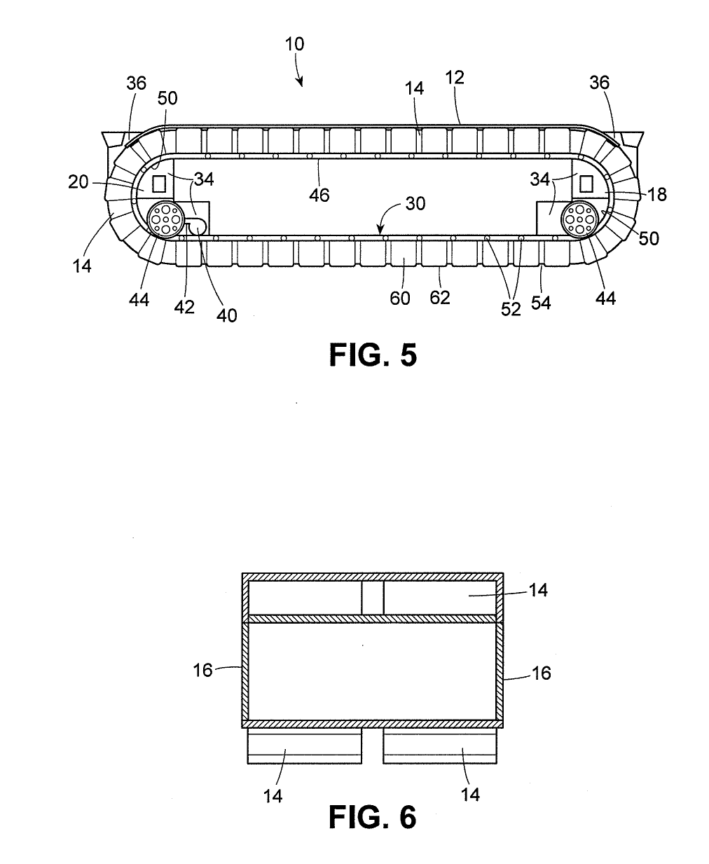

In addition to the payload compartment 28, the front and rear walls 32 of that compartment define utility spaces 34 at the fore and aft ends of the vehicle. These compartments provide space for personnel being transported and lead to central command and control centers 36 at the front and rear of the vehicle. As illustrated in FIG. 5, the compartments 34 may contain the power plant 40 for the vehicle, which is preferably a diesel engine or engines, connected to a motor/speed reducer 42. The speed reducer is connected to a drive gear 44 located within a sealed compartment in the space 34 where it engages the track 14.

The tracks 14 are configured to engage the teeth on the sprockets 44 that so the tracks rotate along an oval path of travel, as seen FIG. 5. The track can include an integral link chain or ribbed belt for this purpose. The oval path of travel for the tracks is defined by the deck 30, the ceiling 46 of the payload space 28, and end walls 50 at the fore and aft ends of the spaces 34 and the bottom of deck 28. Preferably a plurality of rollers 52 are mounted on the exterior of these surfaces for guiding movement of the track along its path of travel.

The tracks 14 can be formed in any convenient manner. For example, they may be formed as an elongated belt on which a plurality of buoyant chambers 60 are pivotally mounted in any convenient or known manner. These chambers which are preferable formed of a flexible compliant material can be located between separate tread members 62, which overlie the chambers thereby to provide a substantially continuous, albeit segmented, surface for the track. In addition, these tread segments will provide surfaces 54 that give traction to the track when it is engaged on the ground or which act as propulsion surfaces when the vehicle is operating on the surface of the water. By this arrangement the track will provide a shock absorbing function when the vehicle arrives on a beach and will flex to accommodate variations in terrain.

Where the vehicle is intended for use solely as an amphibious vehicle, the chambers 60 of the track 14 can be air inflated or contain buoyant material to support the entire vehicle and its payload on the surface of the water. As the treads move through the water, the surfaces 54 of the tread segments 62 act as paddles propelling the vehicle in the appropriate direction. Steering is accomplished by varying the speeds of rotation of the respective tracks 14. Additionally, a rudder mechanism can of course be provided.

When the vehicle is intended to operate as a submersible, the chambers 60 of the treads 14 can be provided with buoyancy control systems which allow the chambers to be totally or partially flooded, thereby to submerge the vehicle. Alternatively, the payload compartment 28 may have ballast tanks mounted therein. In either case the vehicle can then operate beneath the surface of the water using a vertical periscope exhaust for the power plant, or under battery power for a stealthy approach a beach for discharge of the payload. The tracks 14 will operate on the sea floor, in the same way they would operate on the beach.

Obviously, such tracks would be formed of appropriate materials to resist damage from the sea bed. As seen in FIGS. 4 and 6, the tracks 14 extend across the majority of the width of the vehicle. In their upper flight or path of travel the tracks are protected by the side walls 18 of the shell or hull 12. Along their lower path of travel they are partially protected by those side walls.

Because of the very large the width of the tracks relative to the vehicle, which width can occupy eighty to ninety percent or more of the width of the vehicle, they are able to both achieve buoyancy and traction over soft wet ground. In addition, as the buoyant track system enters the unloading zone and is propelled onto the beach, the buoyant tracks behave as a shock absorber as well as a complaint track accommodating surface variations. The track further provides a cushioning effect to soften the landing process in plunging surf conditions.

Another advantage of the present invention is that the buoyant track amphibious transporter disclosed herein is readily scalable and can be sized to fulfill a variety of amphibious transport needs. As noted above, the payload bay and/or the buoyancy tracks can be augmented with variable ballast buoyancy control to permit an underwater operating mode for low observable or stealthy needs.

While the principal means of propulsion described herein is through the track arrangement, it is to be understood that this propulsion mode can be augmented by other propulsion means attached to the main structure such as, propellers, thrusters, water jets, paddles or other known means for water propulsion.

While the present invention has described herein with reference to particular embodiment shown in the drawings, it is to be understood that various changes and modifications may be effected therein by those skilled in the art without departing from the scope or spirit of this invention.

What is claimed is:

1. An amphibious vehicle adapted to traverse water, and soft or firm soil comprising,
a housing including a payload bay;
at least one buoyant endless track, providing the majority of the vehicle's buoyancy; said housing defining a path of travel for said at least one track having a pair relatively flat flights spaced apart such that the track surfaces encompass said payload bay; and
means for driving said at least one buoyant track to provide motive power and/or traction on soil and/or on water.

2. A vehicle as defined in claim 1 including compartments in said housing for equipment and personnel to be transported.

3. A vehicle as defined in claim 1 including a pair of buoyant tracks encompassing said payload bay.

4. A vehicle as defined in claim 3 wherein the total width of said tracks is more than 50% of the width of the vehicle.

5. A vehicle as defined in claim 4 wherein the width of said tracks is at least 80% of the width of the vehicle.

6. A vehicle as defined in claim 1 wherein the buoyant track is inflatable to maintain the desired shape and to provide buoyancy for the vehicle.

7. A vehicle as defined in claim 1 wherein the buoyant track is at least partly filled with a buoyant material to maintain the desired shape and to provide buoyancy for the vehicle.

8. A vehicle as defined in claim 1 wherein the buoyant track 1 comprises a drive belt and buoyant attachments that provide flotation and traction.

9. A vehicle as defined in claim 1 including means for providing water traction attached to the buoyant track.

10. A vehicle as defined in claim 1 including means for providing water propulsion in addition to said track main structure.

11. A vehicle as defined in claim 10 wherein said means for providing water propulsion comprises at least one of the group consisting of propellers, thrusters, water jets and paddles.

12. A vehicle as defined in claim 1 including a means for water steerage attached to the main structure.

13. A vehicle as defined in claim 12 wherein said water steerage means comprises a rudder.

14. A vehicle as defined in claim 1 wherein said housing including payload bay doors mounted thereon to open and close said bay and providing an off-loading ramp when open.

15. An amphibious water vehicle including a housing having a pay load bay; said housing including a top and a pair of spaced side walls, including lower edges; a pair of buoyant drive tracks; means in said housing for defining a path of travel for said tracks including a pair of relatively straight upper and lower flights wherein the upper flights are above the payload bay and below the top of the housing and a lower flights are below the payload bay and the tracks extend beyond the lower edge of the side wall whereby the tracks encompass the side walls and the tracks are at least partly exposed in their lower flights to provide motive power and/or traction on sail and/or on water.

16. A vehicle as defined in claim 14 including means for driving said buoyant tracks.

17. A vehicle as defined in claim 15 wherein the total width of said tracks is more than 50% of the width of the vehicle.

18. A vehicle as defined in claim 16 wherein the width of said tracks is at least 80% of the width of the vehicle.

19. A vehicle as defined in claim 17 wherein said tracks are formed of a flexible, compliant material.

20. A vehicle as defined in claim 18 wherein the buoyant track is inflatable to maintain the desired shape and to provide buoyancy for the vehicle.

21. A vehicle as defined in claim 18 wherein the buoyant track is at least partly filled with a buoyant material to maintain the desired shape and to provide buoyancy for the vehicle.

22. A vehicle as defined in claim 18 including means for providing water traction attached to the buoyant track.

23. A vehicle as defined in claim 18 wherein said housing including payload bay doors mounted thereon to open and close said bay and providing an off-loading ramp when open.
